(19) United States
(12) Patent Application Publication
(10) Pub. No.: US 2026/0077289 A1
(43) Pub. Date: Mar. 19, 2026

(54) REDUCTION OF EMISSIONS IN THE VEHICLE INTERIOR

(71) Applicant: AUDI AG, lngolstadt (DE)

(72) Inventors: Simone MÜLLER-HELLWIG, lngolstadt (DE); Hagen SEIFERT, Regensburg (DE); Alexander KRAJETE, Pasching (AT)

(73) Assignee: AUDI AG, lngolstadt (DE)

(21) Appl. No.: 19/329,717

(22) Filed: Sep. 16, 2025

(30) Foreign Application Priority Data
Sep. 19, 2024 (DE) 102024126864.6

(51) Int. Cl. B01D 46/00; B60H 3/06

(52) U.S. Cl. CPC B01D 46/0036; B60H 3/0608; B01D 2253/108; B01D 2253/1124; B01D 2257/404; B01D 2258/06; B01D 2259/4566; B60H 2003/0691

(57) ABSTRACT

A filter unit for removing gaseous compounds (NOₓ, SOₓ, VOC, CO etc.) as well as bacteria and viruses from air, an arrangement for reducing the pollutant content of the air in an interior, in particular a motor vehicle interior, and a method for removing gaseous pollutants as well as bacteria and viruses from the air fed into an interior, in particular a vehicle interior.

### FIELD

The invention relates to a filter unit for removing gaseous compounds (NOₓ, SOₓ, VOC, CO etc.) as well as bacteria and viruses from air, an arrangement for reducing the pollutant content of the air in an interior, in particular a motor vehicle interior, and a method for removing gaseous pollutants as well as bacteria and viruses from the air fed into an interior, in particular a vehicle interior.

### BACKGROUND

Currently, there are only very limited options for reducing exhaust gas components in the vehicle interior, for example those coming from vehicles driving ahead. One possibility is the “recirculation setting” on the air conditioning system. This prevents a lot of air from being sucked in from outside. Another option is to use the HEPA/activated carbon filters that are already installed in some vehicles. However, both technical solutions can only be used to a limited extent for NOₓ reduction.

The disadvantage of the “recirculation setting” is that pollutants such as CO₂ and NOₓ accumulate very quickly in the interior air, so this is only a very time-limited measure. In addition, the humidity also increases rapidly. HEPA filters in combination with activated carbon filters do have a filtering effect, but many filters have only a very limited capacity and the loaded filters must be replaced; the loaded material cannot be recycled.

From DE10 2018 114 351 A1, a filter medium for an interior air filter or for a fuel cell is known, which comprises at least three active layers: a catalytic active layer comprising catalytic activated carbon particles, a second active layer comprising impregnated or catalytic activated carbon particles, and a third active layer comprising impregnated or catalytic activated carbon particles, wherein at least one active layer comprises impregnated activated carbon particles and the three active layers are different from one another. The filter medium is used to filter out nitrogen and sulfur oxides from the supplied air. Furthermore, a filter media body comprising the filter medium; a filter element comprising the filter media body or the filter medium; an air filter comprising the filter element or the filter media body or the filter medium and a manufacturing method for producing the filter medium are described.

DE 10 2005 022 844 A1 discloses a method for separating odorous substances from gases, in which the gas is brought into contact with at least one filter containing a porous metal-organic framework material, wherein the framework material contains at least one at least bidentate organic compound coordinately bound to at least one metal ion.

### SUMMARY

Against this background, the object of the invention is to provide devices and methods with which gaseous compounds (NOₓ, SOₓ, VOC, CO, formaldehyde, etc.) can be removed from indoor air.

The invention relates to a filter unit for removing gaseous pollutants such as nitrogen oxides, sulfur oxides, VOC, carbon monoxide or formaldehyde from the air in a closed space (interior air). In one embodiment, the closed space is a vehicle interior, in particular a passenger compartment.

The filter unit comprises a closed housing containing adsorber granulate with an inlet for ambient air and an outlet for filtered air. In one embodiment, air can be introduced into the filter unit at one end of the housing and air can be discharged from the filter unit at an opposite end. The filter unit can be used to filter fresh air supplied to the interior and is placed accordingly in the air supply. In one embodiment, the filter unit is arranged in the front of the vehicle, for example in or on the water tank, in order to filter the intake air before it flows into the air conditioning system. In another embodiment, the filter unit is built into the leaf catcher. In yet another embodiment, the filter unit is integrated into the air conditioning system, which may eliminate the need for other filters (e.g. HEPA filters). The filter unit can be designed so that it does not need to be replaced over the lifetime of the vehicle.

The filter unit is filled with adsorbent granulate, which can be easily replaced and recycled. The adsorbent granulate can be removed and replaced, for example when the filter unit is saturated with gaseous compounds (NOₓ, SOₓ, VOC, CO, etc.). The granulate can be recycled by separating the adsorbed molecules from the granulate, for example by heat. The resulting gas stream is collected and fed into conversion processes, for example for the production of nitric acid. By using the filter unit, a permanent reduction of the concentration of gaseous pollutants in the interior can be achieved.

The adsorber granulate contains manganese-containing granules comprising a mixture of aluminum hydroxide diacetate (Al(CH₃COO)₂OH, acetic acid alumina) and permanganate. This is a so-called “engineered media”. In one embodiment, the granulate is prepared by mixing the acetic acid alumina with the permanganate in a large drum to obtain a homogeneous mixture. This has the advantage that the entire pellet is impregnated with permanganate, which results in better service life and separation performance compared to other materials that are obtained by immersing a finished pellet in a permanganate solution.

In one embodiment, the manganese-containing granulate contains potassium permanganate. In another embodiment, the manganese-containing granulate contains potassium permanganate. In one embodiment, the manganese-containing granulate contains from 5 wt % to 20 wt % permanganate, for example from 8 wt % to 15 wt % permanganate. In one embodiment, the manganese-containing granulate contains at least 8 wt % of potassium permanganate. In another embodiment, the manganese-containing granulate contains at least 12 wt % of potassium permanganate.

In one embodiment, the manganese-containing granulate has an average diameter of 1-2 mm. In one embodiment, the bulk density of the manganese-containing granulate is 0.6-0.8 kg per liter.

In one embodiment, the adsorbent granulate also comprise at least one zeolite. Zeolites that can adsorb nitrogen oxides are known in principle to those skilled in the art. Examples comprise ZSM-5, zeolite Y and mordenite. In one embodiment, natural zeolite with a high silicon content is used, for example mordenite or clinoptilolite.

In one embodiment, the adsorber granulate contain from 5 wt. % to 20 wt. % manganese-containing granulate, for example from 5 wt. % to 10 wt. % manganese-containing granulate, and from 80 wt. % to 95 wt. % zeolite, for example from 90 wt. % to 95 wt. % zeolite. The zeolite portion of the adsorber granulate is fully regenerable.

A difference between the adsorber granulate according to the invention and zeolite-based adsorber granulate of the prior art is that in the adsorber granulate according to the invention the zeolite itself acts as the active material. No coated zeolite materials are used. Furthermore, the absorption of NOₓ from the air is independent of the volume flow. Furthermore, the input concentration is also irrelevant. Regardless of the setting on an air conditioning system that transports up to 10 kg/min of air, at least 80 wt. % NOₓ was adsorbed in the practical test, at concentrations of 10 to 2,000 ppb NOₓ in the intake air.

The filter unit according to the invention offers extensive protection against gaseous pollutants such as NOₓ, wherein the adsorber material according to the invention adsorbs at least 70 wt. %, for example >80 wt. % of the NOₓ contained in the air stream. In addition to NOₓ, other gaseous pollutants are also adsorbed, such as SOₓ, VOC, CO and formaldehyde. In addition, bacteria and viruses are also retained in the filter unit according to the invention and deactivated by the manganese-containing granulate.

The adsorbent granulate according to the invention can also be used in a filter unit arranged in the interior of the vehicle, as a stand-alone solution or in combination with the air conditioning system.

The invention also relates to an arrangement for reducing the pollutant content of air in a closed space, for example in a vehicle compartment, comprising a supply system for ambient air in the closed space and/or a recirculation system for circulating air in the closed space, wherein the supply system and/or the recirculation system comprise at least one filter unit according to the invention with adsorbent granulate according to the invention.

In one embodiment, the arrangement comprises both a supply system for supplying ambient air in the closed space and a recirculation system for circulating air present in the closed space. In a further embodiment, both the supply system and the recirculation system comprise a filter unit according to the invention.

The invention also relates to a motor vehicle with an interior and an air conditioning system for the interior, wherein the air conditioning system comprises a filter unit according to the invention.

In one embodiment, the motor vehicle comprises a filter unit according to the invention, which is arranged in a leaf catcher or in a water tank of the motor vehicle and filters air sucked into the motor vehicle before it enters the air conditioning system.

In one embodiment, the motor vehicle comprises control electronics, which are also intended to control the filter unit according to the invention. In a further embodiment, the filter units can be controlled separately by means of a software application (“app”). In one embodiment, the app is installed on a user's mobile device, such as a laptop, tablet or smartphone. In another embodiment, the app is part of a user interface of the on-board electronics of the motor vehicle.

The invention also relates to a method for removing nitrogen oxides from the air in a closed space, in which ambient air is passed through at least one filter unit according to the invention and then fed to the closed space. In one embodiment of the method, the ambient air is outside air which is to be supplied to the closed space. In another embodiment of the method, the ambient air is air present in the closed space. In one embodiment of the method, both the outside air to be supplied to the closed space and the air in the closed space are each passed through a filter unit according to the invention.

By using the arrangement according to the invention, good and fresh air is permanently generated for the occupants of the vehicle. The adsorbent granulate used in the cartridges can be easily removed and replaced after saturation with gaseous pollutants. The granulate can be recycled and the desorbed NOₓ can be recycled for other uses. Further advantages and designs of the invention result from the description and the accompanying drawings.

It is apparent that the above-mentioned features and the features still to be explained hereinafter can be applied not only in the particular specified combination but rather also in other combinations or alone, without leaving the scope of the present invention.

### BRIEF DESCRIPTION OF THE FIGURES

The invention is schematically illustrated in the figures with reference to an embodiment and is described further with reference to the figures. In the figures:

FIG. 1 shows a schematic representation of a motor vehicle with an embodiment of the interior air purification according to the invention;

FIG. 2 shows a diagram of measured nitrogen oxide levels during a test drive of the motor vehicle with a filter unit according to the invention.

### DETAILED DESCRIPTION

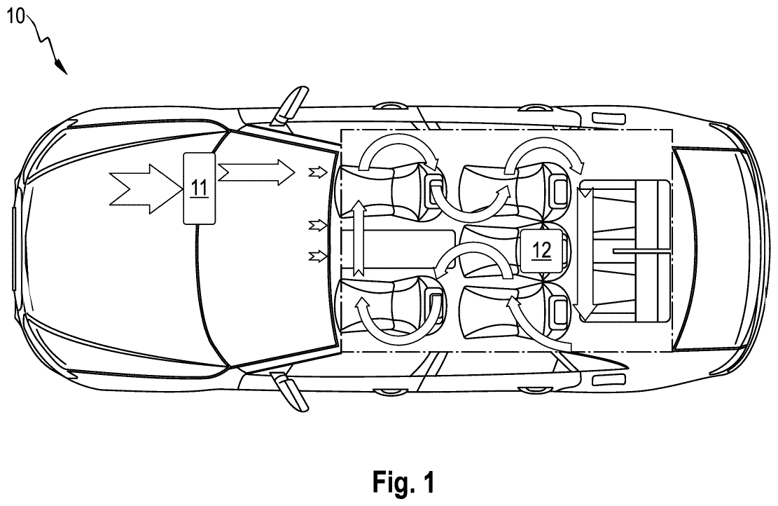

FIG. 1 shows a motor vehicle 10 with an embodiment of the arrangement according to the invention for interior air cleaning. Two filter cartridges 11, 12 are provided, a fresh air filter 11, which is arranged, for example, in the leaf catcher or in the water tank of the motor vehicle, and an interior filter 12, which is arranged in the passenger compartment, for example in the region of the rear seats.

In the fresh air filter 11, the intake air is continuously filtered before entering the air conditioning system by one adsorbing granulate (500-2000 ml), which retains gaseous pollutant molecules as well as bacteria and viruses. When the granulate is passed through once, up to 95% of the nitrogen oxides are removed from the air.

In the interior filter 12, the interior air is continuously filtered by an adsorbing adsorber granulate according to the invention (1000-2000 ml). The interior air is filtered several times through the granulate, the total NOₓ absorption rate is approx. 90%. In practical tests, an interior filter 12 with the adsorber granulate according to the invention resulted in a significant NOₓ reduction in the interior (approx. 50 to 80%). The interior filter 12 can be permanently mounted or removable so that it can be transported when leaving the vehicle and used in a home environment.

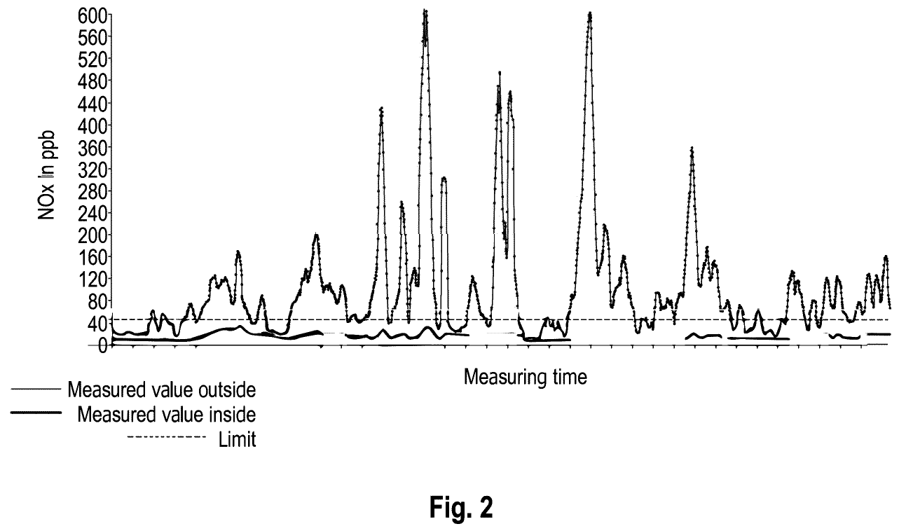

FIG. 2 shows the results of nitrogen oxide measurements carried out during a test drive with a motor vehicle containing a filter unit as fresh air filter according to the invention. The filter unit contained 3-4 l of adsorber granulate. The filter unit does not require any additional fans or similar. The intake air was completely and permanently filtered. The adsorber granulate absorbs NOₓ in a temperature range of −20 to +40 degrees Celsius. In addition to NOₓ, viruses and bacteria are also absorbed, as well as fine dust and unburned hydrocarbons. The graphic illustrates the absorption, the dashed line marks the NOₓ limit value. It is clearly visible that the limit values for NO₂ in the outside air (raw air) supplied to the vehicle are largely exceeded in the area of the test drive. The pollutant load on the vehicle occupants would be constantly very high. By using the fresh air filter arranged in the leaf catcher the NO₂ pollutant load is considerably reduced.

The adsorber granulate can be easily separated and fed into a recycling process in which NOₓ, for example, is separated from the loaded adsorber granulate by increasing the temperature. In a temperature range of 200° C. to 350° C. the molecules detach from the absorber. The NO and NO₂ molecules can react with water in a downstream process to form nitric acid and nitrous acid, respectively.

### LIST OF REFERENCE NUMERALS

10 motor vehicle
11 fresh air filter
12 interior filter

1. A filter unit for removing gaseous pollutants from interior air, in particular interior air of a passenger compartment of a motor vehicle, comprising: a closed housing containing adsorber granulate with an inlet for ambient air and an outlet for filtered air, characterized in that the adsorber granulate contain manganese-containing granulate which comprises a mixture of aluminum hydroxide diacetate and permanganate.

2. The filter unit according to claim 1, wherein the adsorber granulate further contain at least one zeolite.

3. The filter unit according to claim 2, wherein the adsorber granulate contain from 5 wt. % to 20 wt. % manganese-containing granulate and from 80 wt. % to 95 wt. % zeolite.

4. The filter unit according to claim 1, wherein the manganese-containing granulate contains from 5 wt % to 20 wt % permanganate.

5. The filter unit according to claim 2, wherein the zeolite comprises mordenite and/or clinoptilolite.

6. The filter unit according to claim 1, which is configured to be arranged in the front of a motor vehicle, in particular in a leaf catcher or in a water tank.

7. An arrangement for reducing the pollutants content of the air in a closed space, comprising: a supply system for ambient air in the closed space and/or a recirculation system for circulating air present in the closed space, wherein the supply system and/or the recirculation system comprise at least one filter unit according to claim 1.

8. A motor vehicle with an interior and an air conditioning system for the interior, which comprises an arrangement according to claim 7.

9. The motor vehicle according to claim 8, wherein the arrangement comprises a first filter unit which is arranged in a leaf catcher or in a water tank of the motor vehicle and filters air sucked into the motor vehicle before entering the air conditioning system, and optionally a second filter unit which is arranged in a passenger compartment of the motor vehicle and filters the interior air.

10. A method for removing gaseous pollutants as well as bacteria and viruses from the air in a closed space, in which ambient air is passed through at least one filter unit according to claim 1 and then supplied to the closed space.

11. The filter unit according to claim 2, wherein the manganese-containing granulate contains from 5 wt % to 20 wt % permanganate.

12. The filter unit according to claim 3, wherein the manganese-containing granulate contains from 5 wt % to 20 wt % permanganate.

13. The filter unit according to claim 3, wherein the zeolite comprises mordenite and/or clinoptilolite.

14. The filter unit according to claim 4, wherein the zeolite comprises mordenite and/or clinoptilolite.

15. The filter unit according to claim 2, which is configured to be arranged in the front of a motor vehicle, in particular in a leaf catcher or in a water tank.

16. The filter unit according to claim 3, which is configured to be arranged in the front of a motor vehicle, in particular in a leaf catcher or in a water tank.

17. The filter unit according to claim 4, which is configured to be arranged in the front of a motor vehicle, in particular in a leaf catcher or in a water tank.

18. The filter unit according to claim 5, which is configured to be arranged in the front of a motor vehicle, in particular in a leaf catcher or in a water tank.
